(19) United States
(12) Patent Application Publication
(10) Pub. No.: US 2004/0022020 A1
(43) Pub. Date: Feb. 5, 2004

(54) Computer

(76) Inventor: Young-Hie Leem, Seoul (KR)

Correspondence Address: Young-Hie Leem, 1018-23 Sadang-Dong, Dongjak-Gu, Seoul, 156-091, KR

(21) Appl. No.: 10/399,999

(22) PCT Filed: Oct. 4, 2001
(86) PCT No.: PCT/KR01/01651

(30) Foreign Application Priority Data
Oct. 4, 2000 (KR) 2000/58062

(51) Int. Cl. G06F 1/16

(52) U.S. Cl. 361/683

(57) ABSTRACT

A computer, including: two mainboards, each comprising at least one CPU, RAM, video controller and hard disk; a connection device for peripheral devices selectively interconnecting connected peripheral devices to one of said two mainboards mounted within the same computer case by mainboard selection switch 6,7 thereof; at least one auxiliary storage device connected to said connection device for peripheral devices and selectively interconnected to one of said mainboards by mainboard selection switch 6,7 thereof; electric power supply device providing electric power to said two mainboards at the same time or selectively and to the auxiliary storage devices continuously; and a computer case comprising means of mounting said two mainboards, said connection device for peripheral devices, said electric power supply device, and said auxiliary storage devices within itself.

### TECHNICAL FIELD

The present invention relates to the technology of manufacturing computer and more particularly to the technology of manufacturing the computer capable of client/server computer communication networking within itself.

### BACKGROUND ART

Nowadays because of progress of computer technology, most computers including personal computers could be server computer systems in case they have installed server programs for its operating systems. Of course even a server computer can be a client doing the client/server communication network task with other server computer. But there is in personal computers no such computer that is capable of operating two operating systems such as client and server operating programs at the same time within itself.

Generally a set of computer includes:

main body comprising mainboard which includes video-card, CPU (central processing unit) and RAM, hard disk, FD drive, CD-ROM drive, power supply device and computer case, etc.; and

external input/output(I/O) peripheral devices such as monitor, keyboard and mouse, etc.

Theses are basic computer components for recent windows operating system. That is why at least two sets of computers including said components are needed in a client/server computer communication network environment for use in office, home or study. But said network system is kind of burden for personal users if not so for business companies which do many networking tasks. Especially it requires some configuration space and cost to set said two computers on a desk of an individual in home or office for network use. Since server computers do not always use all said devices except said mainboard and hard drive, it is kind of waste that a personal user including a home network user has to buy two full sets of computer systems for networking. However as computer working environment changes into networking one, so it is more and more necessary for even a personal user to have a server for using home network system or studying about the technology of programming related to client/server computer communication network including recently well known P2P (Peer To Peer) computer communication network. Especially Linux operating system including its application program could be acquired freely or cheaply but is a very good operating system as to be operated well even at low speed computer doing powerful function, and there are many users who use it in their server computers for its operating system(OS). For that reason it is more and more necessary for two computers to be set on one desk. But Linux is inconvenient for a person to use as OS for a client computer as it is originally made fit for the use of server computer. Furthermore it is not easy for a person to buy a computer used exclusively for a server of private client/server networking environment because of cost and not using frequently. Of course, there is a technology to use two operating systems such as Window and Linux in one computer selecting one between the two systems at booting time, but that environment could not be a client/server computer communication network one and therefore can not normally operate the client/server computer communication networking based application programs. But if there is a computer that can operate two operating systems at the same time sharing a plurality of peripherals, communicating with each other in client/server computer communication network environment that can be easily configured by the user after buying it, it will solve the above mentioned problems like buying two full sets of computer systems for personal use. And this computer will be useful, economical and convenient for a personal user, especially for a learner about client/server communication network, and a user who wants to configure home network and will contribute to the development of this technical field, besides, a personal user can learn conveniently the technology related to client/server computer communication network without connecting to internet as in prior art.

### DISCLOSURE OF INVENTION

The present invention is to provide the technology of manufacturing a client/server computer that a personal user can buy cheaply and easily configure client/server computer communication network with, as the computer operating environment is rapidly changing into internet based client/server computer communication network, accordingly there is more and more need for configuring computer communication networks even for the uses of study and home network though it is not easy for the reason of expense.

It is an object of the present invention to provide the technology of sharing peripheral storage device and other peripherals by two computers within one computer case.

It is another object of the present invention to provide the technology of manufacturing a computer functioning as two computers for the uses of client and server computer but appearing like one computer.

It is another object of the present invention to provide the technology of manufacturing a computer functioning as two computers for the uses of client and server computers which cost less than in two real computers of the prior art.

It is another object of the present invention to provide the technology of manufacturing the computer contributing to reusing and saving computer components(parts);

The key point of the present invention is as followings:

The present invention is related to technology of manufacturing the computer including two mainboards, each comprising CPU(Central Processing Unit), RAM(Random Access Memory), hard disk and video controller card, within one computer case, therefore capable of sharing peripherals and storage devices by two mainboards within the same computer case while the two computers operate at the same time.

And if in one is installed client OS (operating system) for client computer such as Windows 98, while in the other is installed server OS for server computer such as Linux or NT, therefore said two computers are linked to each other within by computer communication devices such as ethernet card, that computer can be used for a client/server computer.

For that reason, that computer seems to be a normal one computer in appearance but in fact it is a real client/server computer that can operate two computer systems at the same time within itself unlike the computer using the prior art.

In this description, the word “client/server computer” is used to only represent a computer having functionally two computers integrated into one computer case and intended to be used for client and server computer. Full client/server computer will be formed after installing each OS for client or server computer respectively and communication network devices such as ethernet card, etc., in each mainboard to configure communication network between two computers. The reason for calling the present invention as “client/server computer” is that it is much easier to configure client/server computer communication network with this invention than with any computer of the prior art.

In this description of each embodiment of the present invention, Linux is assumed to be used OS for the server computer in that the computer of the present invention will be in most case used by a personal user and Linux is distributed freely or cheaply, but in fact all other OS for the server computer such as NT, etc., could be included if it could be operated in a personal computer without problem.

### BRIEF DESCRIPTION OF DRAWINGS

FIG. 1 is for illustrating a schematic structure of a computer system of the present invention.

FIG. 2 is for illustrating the internal structure of mainboard selection controller of the present invention.

FIG. 3 is for illustrating the structure of a connection device for peripheral devices of the present invention and connected devices.

FIG. 4 is for illustrating the structure of an electric power supply device of the present invention.

FIG. 5 is for illustrating an example of using the present invention in home network.

FIG. 6 is for illustrating a flowchart of steps of composing the computer of the present invention.

### BEST MODES FOR CARRYING OUT THE INVENTION

The objects and characteristics of the present invention will be more easily understood with reference to the accompanying drawings and detailed description hereinafter.

Each term used in this description is specially selected for the convenience of explanation. Therefore, the terms in this description should be interpreted considering their substantial functions.

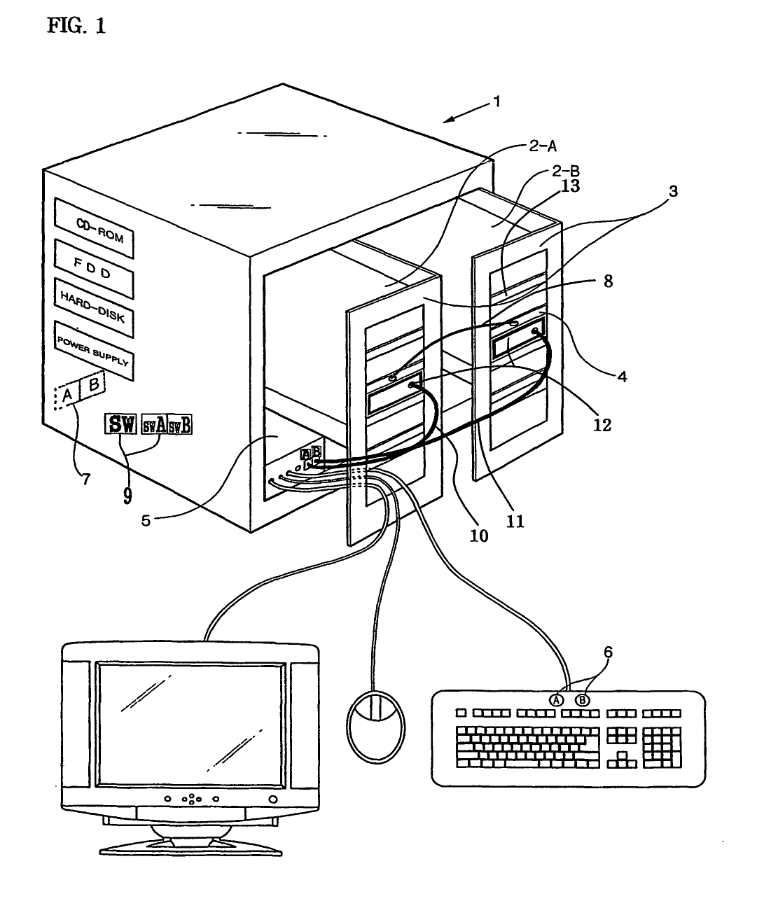

FIG. 1 is for describing a schematic structure of a computer system and the first embodiment of the present invention,

wherein the computer 1 is characteristic of including:

two mainboards 2-A,2-B, each comprising at least one Central Processing Unit(abbreviated as CPU), Main Memory device such as Random Access Memory(abbreviated as RAM), video controller and hard disk;

a connection device 5 for peripheral devices (various peripheral storage devices and external input/output(I/O) peripheral devices etc.) selectively interconnecting said connected peripheral devices to one of said mainboards by mainboard selection switch 6,7 thereof;

at least one auxiliary storage device such as floppy disk drives connected to said connection device 5 for peripheral devices and selectively interconnected to one of said mainboards by mainboard selection switch 6,7 thereof;

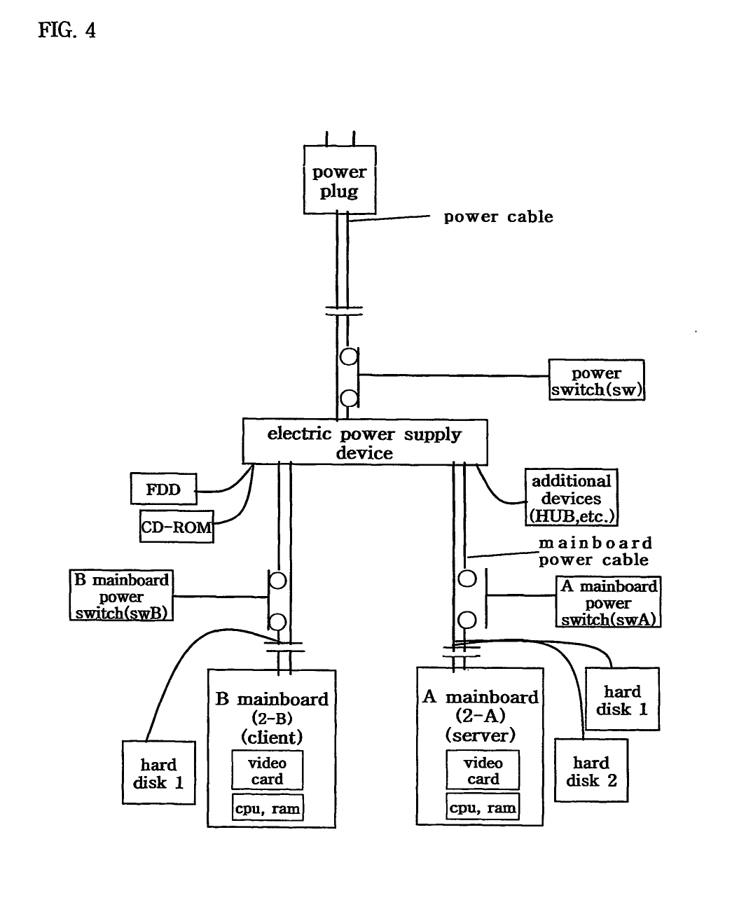

electric power supply device providing electric power to said mainboards at the same time or selectively and to the auxiliary storage devices and additional devices continuously as shown in FIG. 4; and

a computer case comprising means of mounting two said mainboards, said connection device for peripheral devices, said electric power supply device and said auxiliary storage devices and additional devices within itself.

And said computer 1 is characteristic of more including computer communication networking devices 8 for configuring computer communication network within one computer case by connecting two mainboards.

And it is a matter of course that said each CPU, RAM and video controller should be fit in specification for the each corresponding mainboard.

The second embodiment of the present invention is characteristic in that it includes only one mainboard as described in the first embodiment and selectively more includes network devices 8 according to user's need while other things included are the same as in the first embodiment.

Said second embodiment is intended to be used mainly by computer makers for manufacturing a new model computer, in consideration of allowing a consumer to mount one more mainboard into a spare slot for mainboard mounting and computer communication network devices 8 separately in the computer case after buying the computer as described in said second embodiment of the present invention to complete a perfect client/server computer like the computer as described in the first embodiment according to said consumer's need.

The third embodiment of the present invention is characteristic in that it provides the technology of making separately the main parts(components) of the computer of the present invention in the form of articles such as a computer case, a connection device 5 for peripheral devices and an electric power supply device.

Said third embodiment allows a consumer to buy separately said parts of the present invention such as a computer case, a connection device 5 for peripheral devices and/or an electric power device selectively with which to compose a client/server computer of the present invention as described in first embodiment, together with other parts that he/she already have such as used mainboard and used peripheral devices.

More specific description about said each component for various embodiments of the present invention is as followings, but it may be omitted or briefly described about the technology of the prior art.

As shown in FIG. 1, means of mounting two mainboards within said one computer case may be a pair of sliding mainboard cases 3 capable of conveniently mounting or unmounting mainboards, a pair of grooved slots (not shown) for mounting mainboards within the case or a pair of protruded slots (not shown) for mounting mainboards within the case, these are well known technology for those skilled in the art in light of the prior art. And preferably, on the front side of said computer case is attached signal ramps that show the operation state of each computer, which is widely used in the prior art. And preferably, at least one of said two mainboard mounting means is able to have a used mainboard mounted. And said computer case should have means for mounting in the proper position peripheral storage devices (such as FDD, CD-ROM), electric power supply device as shown in FIG. 4 and a first connection unit 5 for peripheral devices to be easily shared by two computers (mainboards) and should be proper size to have all above mentioned components including two mainboards mounted within. And said used mainboard includes one made by widely used standard specification for mainboard.

Said connection device for peripheral devices comprises a first connection unit 5 for peripheral devices and two second connection units 12 for peripheral devices.

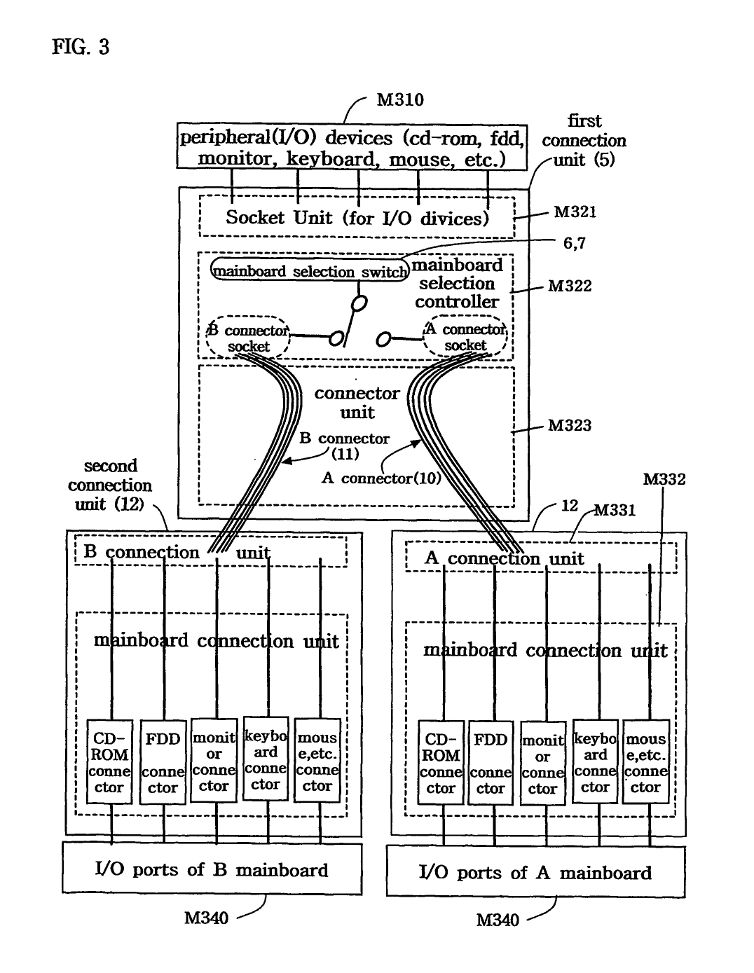

Said first connection unit 5 for peripheral devices comprises a socket unit M321 for connecting peripheral devices, mainboard selection controller M322 and two connector units M323 as shown in FIG. 3,

said socket unit M321 for connecting peripheral devices is means for directly connecting to the matching conductors(terminators) of peripheral devices;

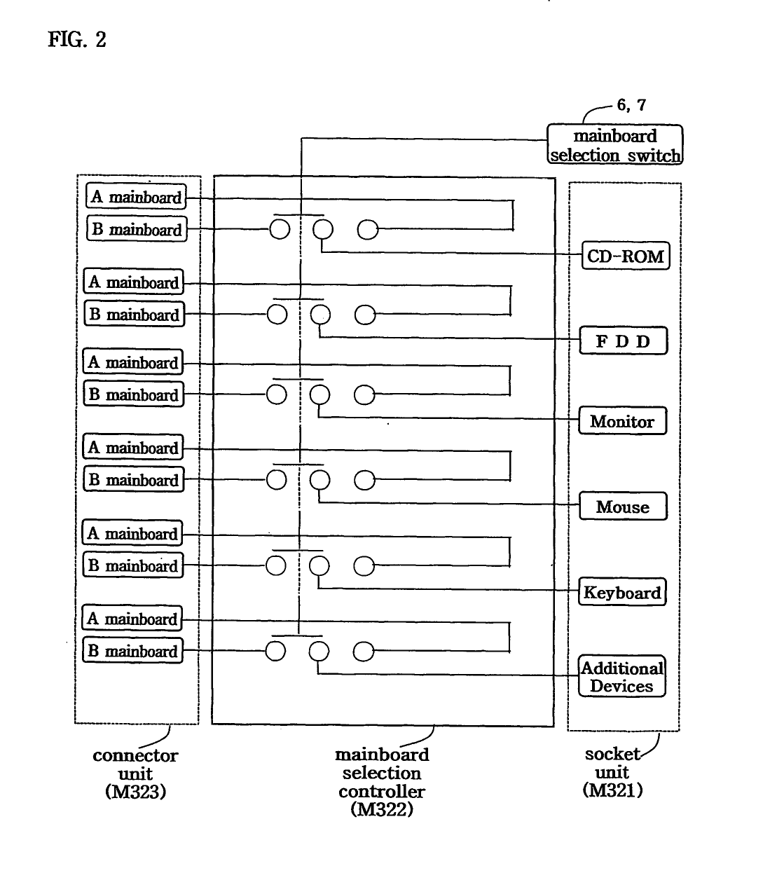

said mainboard selection controller M322 consisting of controller and mainboard selection switch 6,7 is means for selectively interconnecting connected peripheral devices to one of two mainboards through said connector unit M323 by means of said mainboard selection switch 6,7 attached on the computer case or a keyboard as shown in FIG. 2, there in FIG. 1 are illustrated the switch for mainboard 2-A as “A” and the switch for mainboard 2-B as “B”.

Said connector unit M323 is means for transferring the input/output(I/O) signals between said connected peripheral devices and each corresponding second connection unit(or each mainboard), wherein the type of said connector unit M323 may be the form of connector collection each connector corresponding to each matching connector of peripheral device or the form of one consolidated connector into which are consolidated all the functions of connector collection of peripheral devices as shown in FIG. 1 and FIG. 3, there in FIG. 1 are illustrated the connector for mainboard 2-A as “10” and the connector for mainboard 2-B as “11”.

Interface types of said connection device 5 for connecting with the peripheral devices comprise at least one among serial, USB and IEEE1394 according to peripheral devices.

Said peripheral devices M310 comprise all kinds of devices directly connected to first connection unit 5 for peripheral devices and selectively interconnected to one of two mainboards 2-A, 2-B by means of mainboard selection switch 6,7 of mainboard selection controller M322 linked to said first connection unit 5 therefore to be shared by two mainboards, wherein said peripheral devices M310 comprise all kinds of storage devices such as FDD and CD-ROM, etc., mounted within a computer case; and

all kinds of input/output(I/O) peripheral devices such as keyboard, mouse, monitor, camcorder and other storage devices, etc., connected to said connection device 5 from outside the computer case.

Said second connection unit 12 for peripheral devices comprises connection unit M331 for connector unit M323 and mainboard connection unit M332 for peripheral devices as illustrated in FIG. 3; said connection unit M331 is means for connecting to said connector unit M323, said mainboard connection unit M332 is a connector collection set for directly interconnecting each connector of peripheral devices to corresponding I/O port M340 of the mainboard and having connection terminators for electrically coupling with the corresponding I/O ports M340 of the mainboard, especially if the form of said connector unit M323 is consolidated one as illustrated in FIG. 1.

Said electric power supply device as in FIG. 4 is means of providing electric power to said two mainboards at the same time or selectively according to selection of related switches by user and to the auxiliary storage device (such as FD drive and CD-ROM drive) and additional devices separately and continuously while the power switch sw is on, including three power cable collections wherein one is for said storage devices, the others are for two mainboards and attaching hard disks and capable of providing two computers with as much electric power as sufficient for two computers to operate at the same time;

said switches consist of the power switch SW for said electric power supply device itself and the mainboard power switches swA, swB for each corresponding mainboard.

Preferably, said power switch sw and said mainboard power switches swA, swB are separately attached on the proper side of the computer case to be distinguished from each others, there in FIG. 1 are illustrated the power switch for said electric power supply device itself as “sw”, the mainboard power switch for mainboard 2-A as “swA” and the mainboard power switch for mainboard 2-B as “swB”.

It is a matter of course to those killed in the art that said electric power supply device may consist of two separate electric power supply devices of the prior art for providing electric power to each corresponding mainboard respectively, not using said electric power supply device of the present invention illustrated in FIG. 4, in this case the devices which are not provided with electric power all the time continuously (such as peripheral storage devices) may be provided with electric power from the server side electric power supply device or from each corresponding electric power supply device while a computer (mainboard) accesses said peripheral devices by controlling corresponding electric power supply device, etc.

And there in FIG. 1 are illustrated mainboard expanding slots 4 covered with slot covers 13, and into one of said slots of each mainboard is inserted an ethernet card, with UTP cable linking between two ethernet cards to be networked with each other.

Said computer communication network devices 8 include all kinds of devices such as ethernet card, UTP cable, etc., as in the prior art.

FIG.2 illustrates the internal structure of mainboard selection controller M322 of the first connection unit 5 of said connection device for peripheral devices.

As described before, the first connection unit 5 for peripheral devices comprises a socket unit M321 for peripheral devices, mainboard selection controller M322 and two connector units M323 as shown in FIG. 1 and FIG. 3,

wherein said mainboard selection controller M322 is to selectively and electrically interconnect said connected peripheral devices to one of two mainboards through said connector units M323 by mainboard selection switch 6,7 attached on the computer case or a keyboard.

FIG. 3 illustrates the structure of a connection device for peripheral devices of the present invention and connected devices, wherein said connection device for peripheral devices comprises a first connection unit for peripheral devices and two second connection units 12 for peripheral devices, which is specially devised for the present invention to function for a set of peripheral storage devices and other input/output(I/O) peripheral devices to be shared by two computer mounted in one computer case through adjusting mainboard selection switch(es) 6,7, and it is desirable that the first connection unit 5 is installed in the proper location of the computer case and each second connection unit 12 is installed at corresponding each mainboard using expanding slot.

FIG. 4 illustrates the structure of an electric power supply device of the present invention, which is devised specially altering that of the prior art to be fit for the present invention.

There are three power cable collections in said electric power supply device as illustrated in FIG. 4. As soon as the power switch sw is turned on, one collection provides electric power to the devices such as FD drive, CD-ROM drive and additional devices (HUB etc.) continuously while other two collections (mainboard power cable collections) provide electric power to each mainboard and hard disk selectively by adjusting each mainboard power switches swA, swB. Said mainboard power switches swA, swB linked to each mainboard power cable collection are to selectively operate each corresponding mainboard. As said peripheral storage devices (FDD, CD-ROM) and additional devices (HUB etc.) are shared by two computers (mainboards), they have to be provided with electric power constantly while the power switch sw of the electric power supply device itself is turned on. For that reason, the capacity of the electric power supply device should enable two computers to operate at the same time without problem. And preferably, the mainboard power switches swA, swB are attached on different side from the power-switch sw of the electric power supply device itself not to be mixed up with the power switch sw.

Preferably, the mainboard selection switch 6,7 of said connection device 5 and the mainboard power switches swA, swB for each mainboard are joined to be formed as collection switch sets for each corresponding mainboard respectively, and theses switch sets are attached separately on different side from each other in the same computer case not to be mixed up with each other according to uses of two mainboards such as server or client, for instance, server side switch set may be located on rear side of the computer case as it is used occasionally while client side switch set may be located on front side, etc., of the computer case to be used conveniently.

Preferably, wherein the mainboard selection switches 6,7 of said connection device 5 is selection type between two switches and said mainboard power switches swA, swB of electric power supply device is ON/OFF type.

And it is natural to the expert in the art that if each mainboard supports interface types of USB or IEEE1394 for peripheral storage devices and other peripheral devices, said connection device 5 for connecting peripheral devices also can be made to be used only for, or to comprise the function of USB or IEEE1394 interface.

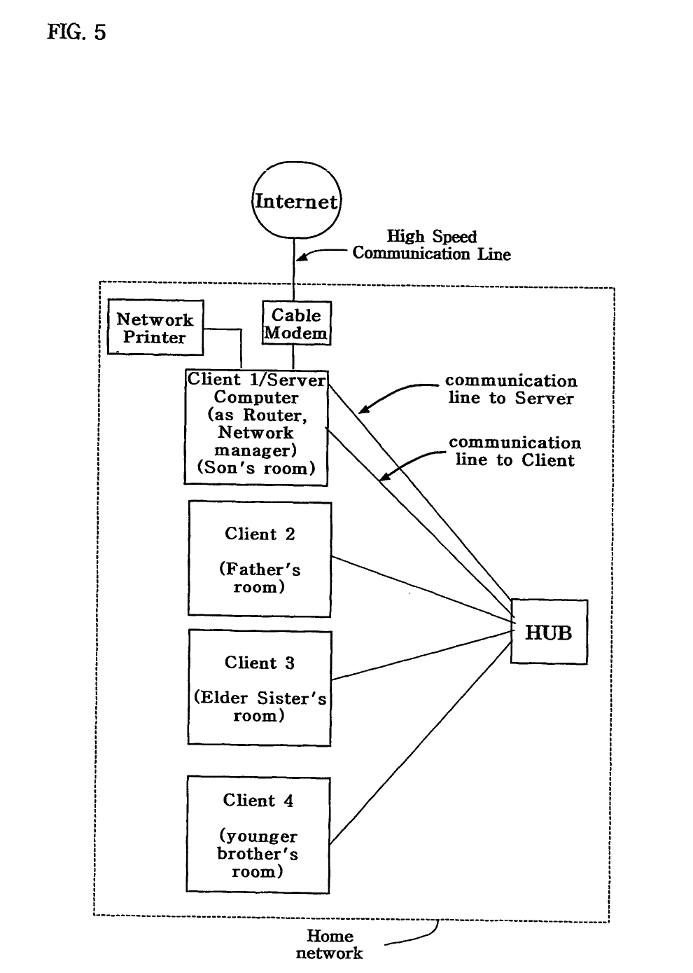

And said computer 1 of the present invention may include HUB as shown in FIG. 5 to be used for a network server and in consideration to this, in FIG. 4 the electric power supply device more comprises additional power cable for additional devices. And it is natural to the expert in the art that said HUB comprises dummy HUB or switching HUB.

Till now, this description is described about the method of sharing peripheral devices and making a client/server computer through joining two prior art mainboards 2-A,2-B, an electric power supply device, a connection device 5 for peripheral devices and peripheral I/O devices together within one computer case. But it is natural to the expert in the art that said mainboard may be single consolidated mainboard into which the functions of said two mainboards are consolidated to lessen the size of the computer of the present invention and to save the cost for manufacturing the present invention, as compared to using two mainboards of the prior art.

FIG. 5 illustrates an embodiment of using the present invention in home network.

As illustrated in FIG. 5, the home network is connected to internet through cable modem, the manager of which network is son and there in son's room is the client/server computer of the present invention. The son manages home network with the sever function of the computer, and with the client function of the computer does word processing, networking with other computers in his home, and manages the server computer of the present invention through client/server computer communication network environment configured within the present invention.

Besides, there in the home are three rooms except son's room, and in each room is a computer. Generally ISP (Internet Service Provider) provides each home with one internet line having a changing IP (Internet Protocol) address and while one computer is connected to internet, other computers in the same home cannot connect to internet.

But in FIG. 5, all computers in home network can connect to internet at the same time, for the computer of the present invention runs router program supporting multiple internet connection all day using the server function of the present invention computer and manages home network. As illustrated in FIG. 5, there is a printer connected to the server computer of the present invention to be shared by all the computers in home network all day. And also there are illustrated two communication lines between son's computer (i.e., client/server computer) and HUB, wherein one is connected to server computer and the other is connected to client computer. But in FIG. 5, as only simple uses of the server function of the present invention are illustrated, there will be many other uses for the present invention such as web server through which one can connect and control various kinds of home electric appliances connected to home network anytime from remote place. And one can transfer data to or receive data from said web server anytime from remote place. For that reason, the uses of the present invention are much more than any other internet devices such as internet TV or set-top box which provides definite internet function, besides, even a person can configure this kind of network environment cheaply and conveniently. Especially in future when the technology of IPv6(Internet Protocol version 6) is widely used, all home or office can get its own IP address, and then home network will be built generally. In that case the present invention may be used as a useful network server for home or small size office network.

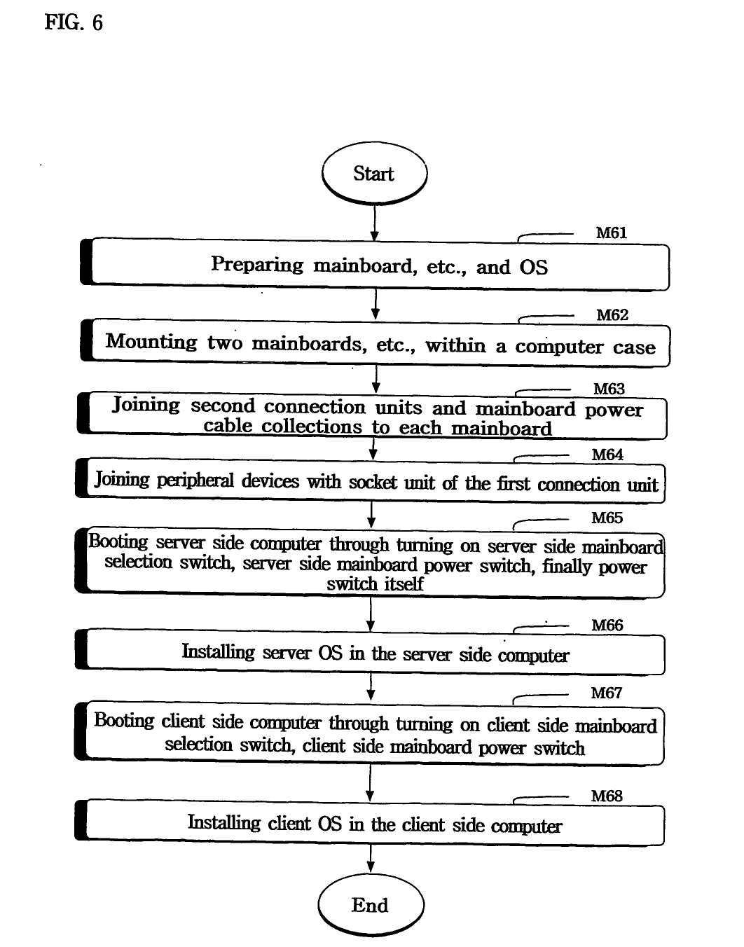

FIG. 6 illustrates a flowchart of steps of composing the computer of the present invention and operating it.

As illustrated in FIG. 6, the steps of installing devices and OS within one computer case include followings:

the step M61 of preparing mainboard and OS;

the step M62 of mounting a connection device 5, an electric power supply device, peripheral storage devices and two mainboards each comprising CPU, RAM, hard disk and video controller within a computer case;

the step M63 of joining two second connection units 12 of the connection device and two mainboard power cable collections with each corresponding mainboard, wherein said second connection unit 12 of the connection device for peripheral devices and two mainboard power cable collections illustrated in FIG. 4 should be joined exactly with each corresponding mainboard to be related to each other through the mainboard selection switches 6,7 and the mainboard power switches swA, swB;

the step M64 of joining peripheral devices and peripheral storage device with socket unit M321 of the first connection unit 5 of the connection device for peripheral devices, wherein peripheral storage devices and additional devices such as HUB, etc., are also joined to electric power supply device, if necessary;

the step M65 of booting server side computer of the present invention through turning on the server side mainboard selection switch 6,7 and the server side mainboard power switch swA, finally the power switch sw of the electric power supply device itself;

the step M66 of installing server OS in the peripheral storage devices such as hard disk for server side computer;

the step M67 of booting client side computer of the present invention through turning on the client side mainboard selection switch 6,7 and the client side mainboard power switch swB sequentially;

the step M68 of installing client OS in the peripheral storage devices such as hard disk for client side computer;

after said steps, the computer of the present invention will operate easily changing environment modes between client mode, server mode and client/server computer communication network mode by selecting mainboard selection switch 6,7 according to user's need.

Of course, only one mainboard(computer) could be booted and operated while the other is off according to user's selection, therefore the present invention can be used for various uses according to the purpose of user by easily changing system environment mode.

It may seem at first that the present invention is very difficult to be operated because of adjusting various switches such as mainboard selection switch 6,7 and mainboard power switches swA, swB, but in practice case it is not so because server side mainboard operates all day and mainboard selection switch 6,7 in most case is switched for client side mainboard, therefore in most case only the client side mainboard power switch swB is switched between ON/OFF options.

As described till now, the present invention includes two mainboards within a single computer case and in appearance seems to be a single computer but in reality is a computer within which two computers operate at the same time, for that reason this computer can operate three operating systems such as client, server, client/server selectively. That's why to buy this computer, only the cost for buying the connection device 5 for peripheral devices will be more needed than in the prior art if he/she uses a used mainboard and installs Linux as server OS for a server side mainboard. Therefore, the computer of this invention is more economical and efficient than that of the prior art.

Till now, the present invention has bee described in detail. However, it should be understood that the said detailed description and specific examples (which indicate preferred embodiments of the invention) are given by way of illustrations only, since various changes and modifications within the spirit and scope of the invention will become apparent to those skilled in the art from this detailed description.

Industrial Applicability

Basically, it is the object of the present invention that even a personal user can have a computer functioning as a server and/or a client computer at low cost, wherein the applicability of which invention in the art is as followings:

1. providing a personal user with saving and benefit

Through the present invention, a personal user can configure client/sever computer communication network with low cost, and can install two computers in the same size space as the size for one computer.

2. providing progress in the art of client/server computer communication network

In the prior art, if one wants to make and exercise the program based on client/server computer communication, he/she has to do it only in the above mentioned network environment, differing from the client only program. But he/she can configure the said network environment at low cost, and without connecting to internet can make and exercise the client/server network program if using the present invention. Thus the present invention will be contributed to enlarge the users of client/server computer communication network and to the progress of the art.

3. expanding distribution of home network

In prior art, it is not easy to configure home network because of cost, but if using the present invention it is easy, and as the computer of the present invention can be used as a router, etc., one internet line can be shared at the same time by all computers in the home network managed by the server function of the present invention, besides, the present invention can be used for many other uses such as web server, etc., for instance, when it is used as a web serve of home network, through which one can control various kinds of home electric appliances connected to said home network anytime from remote place, for the specific technology about which, refer to the patent application No. kr 10-1998-0019264, issued date:May 27, 1998, by Samsung electronic co.

4. enlarging users of Linux

The present invention is especially helpful for Linux. Though Linux is not so good for a personal user to use as a client OS because of insufficient client application programs, etc., but it is a good OS for server use especially because of being a freely or cheaply distributed system. For that reason, if combining with the server function of the present invention, even a personal user can easily have a server computer, therefore it will contribute to enlarge users of Linux and to the progress of the art so much.

5. enlarging users of the technology of P2P communication network

The technology of P2P (Peer to Peer) computer communication network provides computer communication network to client computers without intermediation of server computer of ISP, etc., through IP address of each matching computer. Even this technology can be practicable while each matching computer is operating but in most case, client computer is not used all day, which prevents this technology from widely using. But this invention can easily solve said problem of the prior art, for one can use this invention as a server computer without additional cost.

6. contribution to reuse of used computer components

The present invention is also characteristic of sharing peripheral devices by two mainboards mounted within single computer case, and if a person installs Linux as server OS for one mainboard, even used mainboard having low speed CPU such 486 cpu etc., can be used as server side mainboard, which allows user to have a server computer freely or cheaply. Especially as the progress rate of computer technology is more rapid, so the discarded mainboards are more. But in the present invention, many of said used mainboards can be reused for server or client computers without problem, which is helpful for resource reuse and preservation of nature.

What is claimed is:

1. A computer, including:
two mainboards, each comprising at least one CPU, RAM, video controller and hard disk;
a connection device for peripheral devices selectively interconnecting connected peripheral devices to one of said two mainboards mounted within the same computer case by mainboard selection switch 6,7 thereof;
at least one auxiliary storage device connected to said connection device for peripheral devices and selectively interconnected to one of said mainboards by mainboard selection switch 6,7 thereof;
electric power supply device providing electric power to said two mainboards at the same time or selectively and to the auxiliary storage devices continuously; and
a computer case comprising means of mounting said two mainboards, said connection device for peripheral devices, said electric power supply device, and said auxiliary storage devices within itself.

2. A computer, including:
one mainboard comprising at least one CPU, RAM, video controller and hard disk;
a connection device for peripheral devices selectively interconnecting connected peripheral devices to one of two mainboards mounted within the same computer case by mainboard selection switch 6,7 thereof;
at least one auxiliary storage device connected to said connection device for peripheral devices and selectively interconnected to one of said mainboards by mainboard selection switch 6,7 thereof;
electric power supply device providing electric power to said two mainboards at the same time or selectively and to the auxiliary storage devices continuously; and
a computer case comprising means of mounting two mainboards, said connection device for peripheral devices, said electric power supply device and said auxiliary storage devices within itself.

3. The computer of claim 1 or 2, wherein the computer more includes computer communication networking devices for configuring computer communication network within one computer case by connecting two mainboards.

4. The computer of claim 1 or 2, wherein said means of mounting two mainboards within one computer case is a pair of sliding mainboard cases capable of conveniently mounting or unmounting mainboards, a pair of grooved slots for mounting mainboards within the case or a pair of protruded slots for mounting mainboards within the case.

5. The computer of claim 1 or 2, wherein at least one of said two mainboard mounting means is able to have a used mainboard mounted which includes the mainboard made by widely used standard specification for mainboard.

6. The computer of claim 1 or 2, wherein said connection device for peripheral devices comprises a first connection unit 5 for peripheral devices and two second connection units 12 for peripheral devices.

7. The computer of claim 6, wherein said first connection unit 5 for peripheral devices comprises socket unit M321, mainboard selection controller M322 and two connector unit M323;
said socket unit M321 is means for directly connecting to the matching conductors (terminators) of peripheral devices,
said mainboard selection controller M322 consisting of controller and mainboard selection switch 6,7 is means for selectively interconnecting connected peripheral devices to one of two mainboards through said connector unit M323 by means of said mainboard selection switch 6,7 attached on the computer case or a keyboard,
said connector unit M323 is means for transferring the input/output signals between said connected peripheral devices and each corresponding mainboard, wherein the type of said connector unit M323 is the form of one connector collection each connector corresponding to each matching connector of peripheral device or the form of one consolidated connector into which are consolidated all the functions of said connector collection of peripheral devices.

8. The computer of claim 7, wherein said second connection unit 12 for peripheral devices comprises connection unit M331 and mainboard connection unit M332;
said connection unit M331 is means for connecting to said connector unit M323,
said mainboard connection unit M332 is a connector collection set for directly interconnecting each connector of peripheral devices to the corresponding I/O port M340 of the mainboard and having connection terminators for electrically coupling with the corresponding I/O ports M340 of the mainboard.

9. The computer of claim 1 or 2, wherein said peripheral devices M310 comprise all kinds of devices directly connected to first connection unit 5 for peripheral devices and selectively interconnected to one of two mainboards 2-A, 2-B by means of mainboard selection switch 6,7 linked to said first connection unit 5 therefore to be shared by two mainboards.

10. The computer of claim 1 or 2, wherein said peripheral devices M310 comprise:
all kinds of storage devices such as FDD and CD-ROM, etc., mounted within a computer case; and
all kinds of input/output peripheral devices such as keyboard, mouse, monitor, camcorder and other storage devices, etc., connected to said connection device 5 from outside the computer case.

11. The computer of claim 1 or 2, wherein interface types of said connection device 5 for connecting with peripheral devices comprise at least one among serial, USB and IEEE1394 according to peripheral devices.

12. The computer of claim 1 or 2, wherein said electric power supply device as in FIG. 4 more comprises means of providing electric power for additional devices continuously.

13. The computer of claim 1 or 2, wherein said electric power supply device as in FIG. 4 is means of providing electric power to said two mainboards at the same time or selectively according to selection of related switches and to the auxiliary storage devices and additional devices continuously while said power supply device is on, capable of providing two computers with as much electric power as sufficient for two computers to operate at the same time;
said switches consist of the power switch sw for said electric power supply device itself and the mainboard power switches swA, swB for each corresponding mainboard, and are separately attached on the proper side of the computer case to be distinguished from each other.

14. The computer of claim 12, wherein said electric power supply device consists of two separate electric power supply devices of the prior art for providing electric power to each corresponding mainboard respectively.

15. The computer of claim 1 or 2, wherein the mainboard selection switch 6,7 and the mainboard power switches swA, swB for each mainboard are joined to be formed as collection switch sets for each corresponding mainboard, and are attached separately on different side from each other in the same computer case according to uses of two mainboards such as server or client, wherein said mainboard selection switch 6,7 of said connection device 5 is selection type between two switches and said each mainboard power switch swA, swB of electric power supply device is ON/OFF type.

16. The computer of claim 1 or 2, wherein said computer more includes HUB like dummy HUB or switching HUB.

17. The computer of claim 1 or 2, wherein said HUB is provided with electric power from electric power supply device mounted in said computer case.

18. The computer of claim 1 or 2, wherein said mainboard is single consolidated mainboard into which the functions of said two mainboards are consolidated.

19. A computer case comprising means of mounting followings within itself:
two mainboards, each comprising at least one CPU, RAM, video controller and hard disk;
a connection device for peripheral devices selectively interconnecting connected peripheral devices to one of said two mainboards mounted within the same computer case by mainboard selection switch 6,7 thereof;
at least one auxiliary storage device connected to said connection device for peripheral devices and selectively interconnected to one of said mainboards by mainboard selection switch 6,7 thereof; and
electric power supply device providing electric power to said two mainboards at the same time or selectively and to the auxiliary storage devices continuously.

20. The computer case of claim 19, wherein said means of mounting two mainboards within one computer case is a pair of sliding mainboard cases capable of conveniently mounting or unmounting mainboards, a pair of grooved slots for mounting mainboards within the case or a pair of protruded slots for mounting mainboards within the case.

21. The computer case of claim 19, wherein at least one of said two mainboard mounting means is able to have a used mainboard mounted which includes the mainboard made by widely used standard specification for mainboard.

22. The computer case of one of claims 19 to 21, wherein said computer case more includes means of mounting HUB like dummy HUB or switching HUB.

23. The computer case of one of claims 19 to 21, wherein said computer case comprises means of attaching the mainboard selection switch 6,7 and the mainboard power switches swA, swB for each mainboard, wherein said mainboard selection switch 6,7 and said mainboard power switches swA, swB are joined to be formed as collection switch sets for each corresponding mainboard, and are attached separately on different side from each other in the same computer case according to uses of two mainboards such as server or client, wherein said mainboard selection switch 6,7 for said connection device 5 is selection type between two switches and said each mainboard power switch swA, swB of electric power supply device is ON/OFF type.

24. A connection device for peripheral devices used for composing a computer, mounted within a computer case and selectively interconnecting connected peripheral devices to one of two mainboards mounted within the same computer case by mainboard selection switch 6,7.

25. The connection device of claim 24, wherein said connection device for peripheral devices comprises a first connection unit 5 for peripheral devices and two second connection units 12 for peripheral devices.

26. The connection device of claim 25, wherein said first connection unit 5 for peripheral devices comprises socket unit M321, mainboard selection controller M322 and two connector unit M323;
said socket unit M321 is means for directly connecting to the matching conductors (terminators) of peripheral devices,
said mainboard selection controller M322 consisting of controller and mainboard selection switch 6,7 is means for selectively interconnecting connected peripheral devices to one of two mainboards through said connector unit M323 by means of said mainboard selection switch 6,7 attached on the computer case or a keyboard,
said connector unit M323 is means for transferring the input/output signals between said connected peripheral devices and each corresponding mainboard, wherein the type of said connector unit M323 is the form of one connector collection each connector corresponding to each matching connector of peripheral device or the form of one consolidated connector into which are consolidated all the functions of said connector collection of peripheral devices.

27. The connection device of claim 26, wherein said second connection unit 12 for peripheral devices comprises connection unit M331 and mainboard connection unit M332;
said connection unit M331 is means for connecting to said connector unit M323,
said mainboard connection unit M332 is a connector collection set for directly interconnecting each connector of peripheral devices to the corresponding I/O port M340 of the mainboard and having connection terminators for electrically coupling with the corresponding I/O ports M340 of the mainboard.

28. The connection device of one of claims 24 to 27, wherein said peripheral devices M310 comprise all kinds of devices directly connected to first connection unit 5 for peripheral devices and selectively interconnected to one of two mainboards 2-A, 2-B by means of mainboard selection switch 6,7 linked to said first connection unit 5 therefore to be shared by two mainboards.

29. The connection device of one of claims 24 to 27, wherein said peripheral devices M310 comprise:
all kinds of storage devices such as FDD and CD-ROM, etc., mounted within a computer case; and
all kinds of input/output peripheral devices such as keyboard, mouse, monitor, camcorder and other storage devices, etc., connected to said connection device 5 from outside the computer case.

30. The connection device of one of claims 24 to 27, wherein interface types of said connection device 5 for connecting with peripheral devices comprise at least one among serial, USB and IEEE1394 according to peripheral devices.

31. An electric power supply device as in FIG. 4, used for composing a computer, mounted within a computer case and providing electric power to two mainboards mounted within said computer case at the same time or selectively and to the auxiliary storage device shared by said two mainboards continuously.

32. The electric power supply device of claim 31, wherein said electric power supply device more comprises means of providing electric power for additional devices continuously.

33. The electric power supply device of claim 31 or 32, wherein said electric power supply device is means of providing electric power to said two mainboards at the same time or selectively according to selection of related switches and to the auxiliary storage devices and additional devices continuously while said power supply device is on, capable of providing two computers with as much electric power as sufficient for two computers to operate at the same time;
said switches consist of the power switch sw for said electric power supply device itself and the mainboard power switches swA, swB for each corresponding mainboard, and are separately attached on the proper side of the computer case to be distinguished from each other.

34. The electric power supply device of claim 31 or 32, wherein said electric power supply device consists of two separate electric power supply devices of the prior art for providing electric power to each corresponding mainboard respectively.
